(19) United States
(12) Patent Application Publication
(10) Pub. No.: US 2020/0364266 A1
(43) Pub. Date: Nov. 19, 2020

(54) GENERATING DYNAMIC AND AUTOMATIC VISUALIZATIONS OF A SEMANTIC META MODEL

(71) Applicant: INTERNATIONAL BUSINESS MACHINES CORPORATION, Armonk, NY (US)

(72) Inventors: Geetha ADINARAYAN, Bangalore (IN); Sathiskumar PALANIAPPAN, Tamil Nadu (IN); Amit Mohan MANGALVEDKAR, Bangalore (IN)

(21) Appl. No.: 16/414,034

(22) Filed: May 16, 2019

(51) Int. Cl. G06F 16/904; G06F 16/28

(52) U.S. Cl. CPC G06F 16/904; G06F 16/288

(57) ABSTRACT

A computer-implemented method includes receiving, by a computer device, a request from a user for a semantic meta model including specified data; generating, by the computer device, the semantic meta model from a database including the specified data; generating, by the computer device, a visualization definition for the semantic meta model, the visualization definition including computer readable instructions for generating an appearance of the semantic meta model on a digital display; and transmitting, by the computer device, the visualization definition to the user as a dimension of the semantic meta model.

### BACKGROUND

The present invention relates generally to semantic meta models and, more particularly, to generating a visualization definition of a requested semantic meta model and transmitting that visualization definition as a dimension of the semantic meta model.

A semantic meta model gives the capability of dynamically augmenting knowledge related to any entity, such as, buildings (smarter buildings), cars (connected cars), assets (asset performance management), etc. It also provides the capability of querying the knowledge at various levels using reasoning queries. For example, in a semantic meta model of a building, one could query for energy consumption of all meters in a specific building and aggregate it by hour, day or month.

### SUMMARY

In a first aspect of the invention, there is a computer-implemented method including: receiving, by a computer device, a request from a user for a semantic meta model including specified data; generating, by the computer device, the semantic meta model from a database including the specified data; generating, by the computer device, a visualization definition for the semantic meta model, the visualization definition including computer readable instructions for generating an appearance of the semantic meta model on a digital display; and transmitting, by the computer device, the visualization definition to the user as a dimension of the semantic meta model.

In another aspect of the invention, there is a computer program product including a computer readable storage medium having program instructions embodied therewith. The program instructions are executable by a computer device to cause the computer device to: receive a request from a user for a semantic meta model including specified data; generate the semantic meta model from a database including the specified data; generate a visualization definition for the semantic meta model, the visualization definition including computer readable instructions for generating an appearance of the semantic meta model on a digital display; and transmit the visualization definition to the user as a dimension of the semantic meta model.

In another aspect of the invention, there is system including a processor, a computer readable memory, and a computer readable storage medium. The system includes: program instructions to receive a request from a user for a semantic meta model including specified data; program instructions to generate the semantic meta model from a database including the specified data; program instructions to generate a visualization definition for the semantic meta model, the visualization definition including computer readable instructions for generating an appearance of the semantic meta model on a digital display; and program instructions to transmit the visualization definition to the user as a dimension of the semantic meta model, wherein the program instructions are stored on the computer readable storage medium for execution by the processor via the computer readable memory.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of an exemplary environment in accordance with aspects of the invention.

FIG. 5 shows a block diagram according to an embodiment of the present invention.

FIG. 6 shows an exemplary visualization according to an embodiment of the present invention.

FIG. 7 shows a flowchart of an exemplary method in accordance with aspects of the invention.

FIG. 8 shows a flowchart of an exemplary method in accordance with aspects of the invention.

### DETAILED DESCRIPTION

The present invention relates generally to semantic meta models and, more particularly, to generating a visualization definition of a requested semantic meta model and transmitting that visualization definition as a dimension of the semantic meta model. According to aspects of the invention, a semantic meta model includes a visualization definition as a dimension of the semantic meta model itself. In embodiments, the semantic meta model includes a visualization that is generated based on a specific user role and a specific user interface (UI) of that user. In this manner, implementations of the invention provide visualizations that are usable by a specific user without the need for coding at the UI.

A semantic meta model is an example of a representation of data that results from a particular query or queries and is presented as a visualization on a digital UI. In embodiments, a semantic meta model dynamically augments knowledge related to a particular subject or entity. As examples, in embodiments, buildings (smarter buildings), cars (connected cars), or assets (asset performance management) are the subject or entity to which the knowledge shown in the semantic meta model pertains.

As explained above, as an example, in a semantic meta model of a building, one could query for energy consumption of all meters in a specific building and aggregate it by hour, day or month. The format of the reasoning query result could vary depending on the semantic meta model implementation (the device on which the semantic meta model is to be displayed). This means the result may not be able to be directly consumed by the front end user interface (UI) layer. This usually results in an intermediate layer or UI layer performing the transformation of output of reasoning queries to the format consumable by a particular UI visualization framework (such as, for example, the C3 software platform, and others).

A customizable UI is desired where the user can display information which is of interest to them as a user (and/or in their particular role) versus being limited to standard dashboards. In embodiments, this desired customization is provided using a novel approach to visualize knowledge in a semantic meta model using visualization itself as one of the knowledge dimensions, and therefore not requiring additional coding.

Embodiments of the invention include: an ability to define a visualization which includes details of what type of chart/card needs to be displayed as one of the semantic meta model dimensions; the ability to associate a semantic meta model reasoning query with a type of visualization; providing a discovery application program interface (API) which is consumable by UI users to list all the possible visualizations available to end users for using it on their respective dashboards; and/or providing a generic API which provides the results of the reasoning query in the format that can be displayed directly on the particular UI.

As discussed below, in embodiments, a visualization definition is one dimension of the semantic meta model itself. A visualization definition includes the program instructions provided to the UI for the UI to display the desired visual image of the results of a particular query or queries. This provides the ability to add required visualizations for different queries as needed. Each instance of a visualization is associated with a reasoning query and the display type. Two examples of queries with respective display types are: give energy usage of a building for the last 30 days as a number; and give energy usage and occupancy for the last 30 days as a multi-line chart.

In embodiments, a visualization engine uses two APIs. For example, the visualization engine may use a “discovery API”, and a “generic API”. In embodiments, the discovery API provides the list of visualizations available to a particular UI. For example, in embodiments, the output of the discovery API will be EnergyUsageBuildingVisualization and EnergyUsageAndOccupancyVisualization.

In embodiments, the generic API provides the data for each available visualization. In embodiments, one API endpoint (for example an end of a communication channel through which the required data is received) is available for each visualization to request data for that visualization instance. The API implementation gets the query associated with the visualization, executes the query, and transforms the output to the required display type (for example: number, line chart, or bar graph) and sends back to the client the visualization that the client can display directly on the UI.

Benefits of embodiments include: providing a way to add and remove the visualization as knowledge gets added or removed from the semantic meta model (for example, when occupancy details are added to the building, a visualization can be added to show energy usage and occupancy together); being generic to any semantic meta model and not specific to any domain and, therefore, being usable by all applications using semantic meta models (for example, if an asset performance management solution uses a semantic meta model, it can display a line chart showing the trend of temperature and pressure from that asset); providing the ability to build a custom dashboard with no coding; providing a way to personalize the UI for an end user role without having to change the code (in embodiments, personalization includes providing a set of visualization for a specific user role such as, for example, an energy manager dashboard), which is achieved by defining new visualizations for a specific user type; and the ability to be extended to provide, based on real usage, the top visualizations on the dashboard.

Benefits from embodiments include providing a way to customize a UI for an end user without having to change the code (in embodiments, customization includes providing the capability to an end user to choose the visualization he or she wants from a set available to that end user role, such as an energy manager being able to choose what she wants to see on her energy management dashboard). This can be achieved by associating visualizations specific to a user in the semantic meta model.

Implementations of the invention improve the performance of a computer-based semantic meta model system by generating a visualization definition for the semantic meta model, the visualization definition including computer readable instructions for generating an appearance of the semantic meta model on a digital display; and transmitting the visualization definition to the user as a dimension of the semantic meta model. In this manner, implementations of the invention provide a visualization that is tailored to the particular user and can be displayed on the user's particular digital display. Implementations of the invention are improvements to the functioning of a computer in that they include a visualization definition specific to a particular user as a dimension of the semantic meta model when the semantic meta model is sent to the user's user interface. Implementations of the invention add unconventional steps to producing a semantic meta model in that they include a visualization definition specific to a particular user as a dimension of the semantic meta model.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

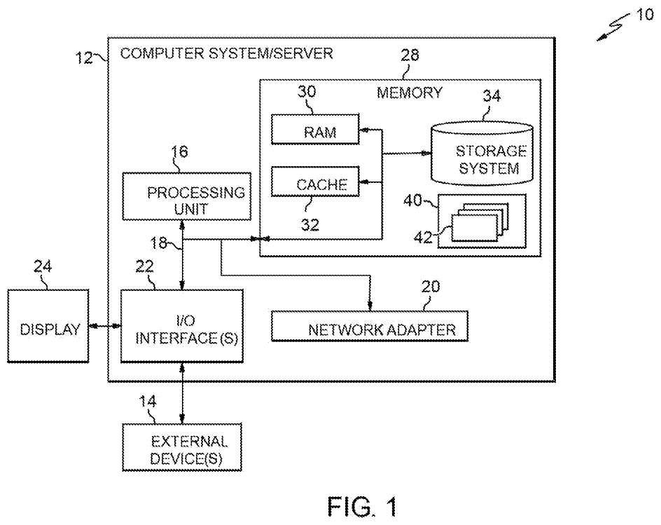

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

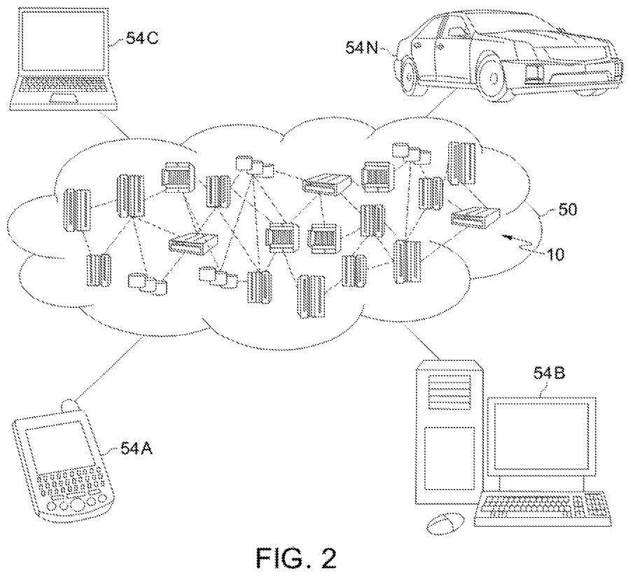

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

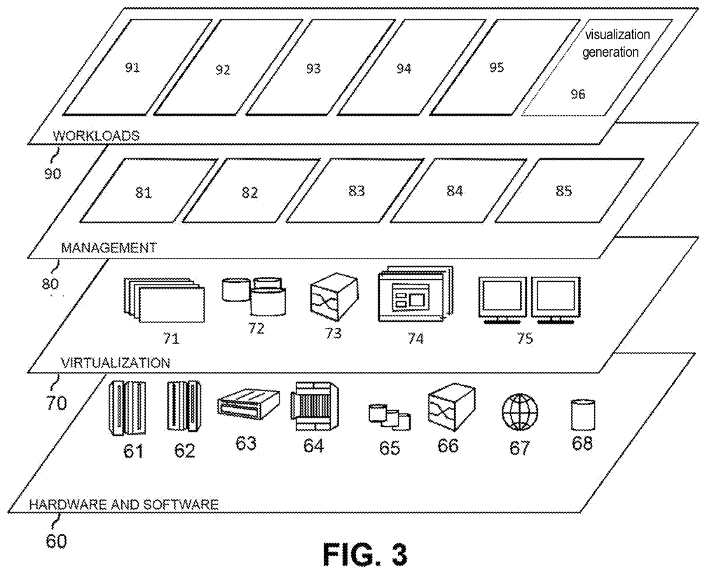

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and visualization generation 96.

Implementations of the invention may include a computer system/server 12 of FIG. 1 in which one or more of the program modules 42 are configured to perform (or cause the computer system/server 12 to perform) one of more functions of the visualization generation 96 of FIG. 3. For example, the one or more of the program modules 42 may be configured to: receive a request from a user for a semantic meta model including specified data; generate the semantic meta model from a database including the specified data; generate a visualization definition for the semantic meta model; and transmit the visualization definition to the user as a dimension of the semantic meta model.

To the extent implementations of the invention collect, store, or employ personal information provided by, or obtained from, individuals, such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

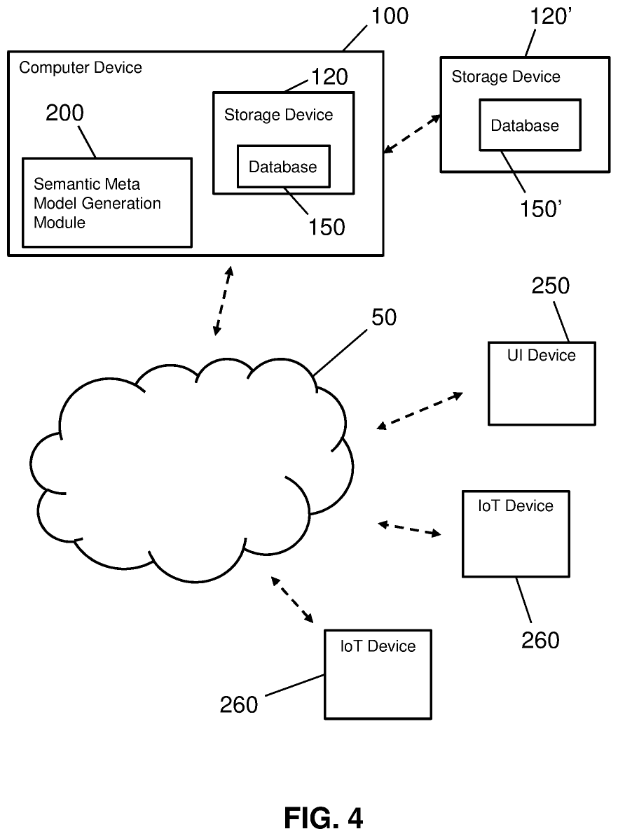

FIG. 4 shows a block diagram of an exemplary environment in accordance with aspects of the invention. In embodiments, the environment includes cloud computing environment 50 through which a computer device 100 communicates with one or more UI devices 250 and/or Internet of Things (IoT) devices 260. In embodiments, computer device 100 includes a semantic meta model generation module 200 that generates sematic meta models based on input from one of UI devices 250 or IoT devices 260 and outputs the semantic meta model, including the visualization definition, to the UI device 250 or IoT device 260. Computer device 100 may be the computer system/server 12 of FIG. 1, and semantic meta model generation module 200 may comprise one or more program modules 42. In embodiments, UI devices 250 and IoT devices 260 are smart phones, tablets, computers, computer monitors, or any electronic device that can display a visualization of a semantic meta model. Semantic meta model generation module 200 accesses data stored in a database 150. In embodiments, database 150 resides on a storage device 120 that is a part of computer device 100. In other embodiments, database 150′ resides on a storage device 120′ that is remote from computer device 100 such as, for example, a storage device that is accessed by computer device 100 through cloud computing environment 50 or some other wireless or wired connection.

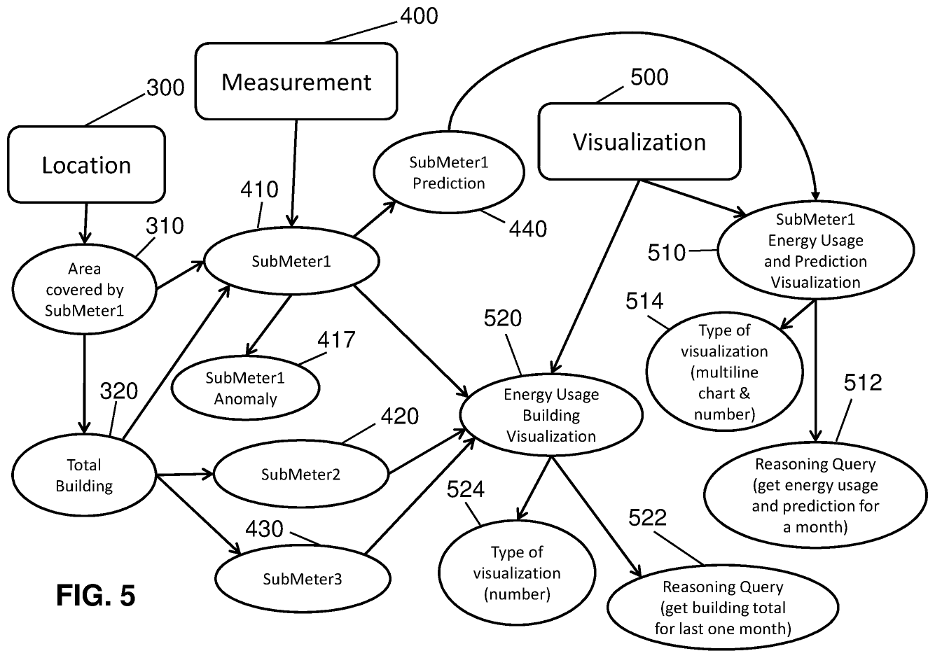

FIG. 5 shows a block diagram of an overview of an exemplary method of producing a semantic meta model in accordance with aspects of the invention. FIG. 5 shows the following three categories of data/processing: the location of measurements being taken; the measurements themselves; and the production of the visualization of those measurements as they are to be displayed on a UI. In this example, data and a visualization thereof are assembled by sematic meta model generation module 200 in response to a query regarding energy usage in a building. The query requests: (1) energy usage for an entire building covered by an energy meter (such as, for example, an electricity meter) called Total Building; and (2) energy usage and prediction for an area of the building covered by an energy meter (such as, for example, an electricity meter) called SubMeter1. Both the area covered by SubMeter1 and the area covered by Total Building are in the same building. As a result, a location 300 is specified as an area covered by SubMeter1 at 310 and the total building area Total Building at 320. The example shown in FIG. 5 is not intended to be limiting, and aspects of the invention described with respect to the example in FIG. 5 can be used in other implementations.

Next, a measurement 400 that the user is interested in is specified by the user as, in this example, a measurement of SubMeter1 410, a measurement of SubMeter2 420, and a measurement of SubMeter3 430. In this example, the location Total Building 320 includes the areas covered by SubMeter1 410, SubMeter2 420, and SubMeter3 430. In this example, the user has specified two pieces of data that the user wants to be shown on the semantic metal model: (1) the energy usage for the entire building (the sum of SubMeter1 410, SubMeter2 420, and SubMeter3 430); and (2) the energy usage for SubMeter1 and a prediction of the energy usage for SubMeter1. The SubMeter1 Prediction 440 takes into account any SubMeter1 Anomaly 417 that might be in SubMeter1 410 and makes an adjustment to SubMeter1 Prediction 440 to allow for the anomaly. For example, if the outside temperature was abnormally high or low in the time period (for example, one month) over which the measurement SubMeter1 410 was taken, then SubMeter1 Anomaly 417 includes data that reflects this abnormal temperature, and SubMeter1 Prediction 440 is adjusted to make the prediction more accurate.

A visualization 500 is created by semantic meta model generation module 200. In this example, visualization 500 has two parts: SubMeter1 Energy Usage and Prediction Visualization 510; and Energy Usage Building Visualization 520. SubMeter1 Energy Usage and Prediction Visualization 510 is based on Reasoning Query 512 (which uses data from SubMeter1 measurement 410 and SubMeter1 prediction 440) and type of visualization 514 (in this example, a multiline chart and a number). Energy Usage Building Visualization 520 is based on Reasoning Query 522 (which uses data from SubMeter1 410, SubMeter2 420, and SubMeter3 430) and type of visualization 524 (in this example, a number). The types of visualizations available are determined by: (1) a discovery application program interface (API) which is consumable by UI users to list all the possible visualizations available to end users for using it on their respective dashboards; and/or (2) a generic API which provides the results of the reasoning query in a format that can be displayed directly on the particular UI. When the types of visualizations are determined, the semantic meta model generation module 200 generates the visualization definition needed to provide the particular IU device 250/IoT device 260 with the required instructions to display the visualization on a display of the IU device 250/IoT device 260.

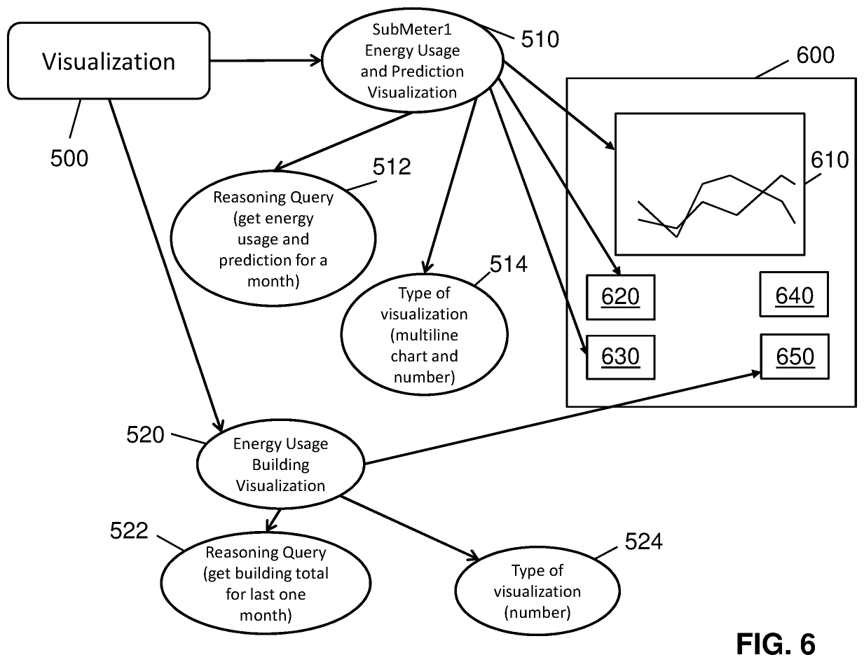

FIG. 6 shows visualization 500 and its subparts from FIG. 5, as well as a display 600 that displays visualization 500. In embodiments, display 600 is a smart phone, tablet, computer, or other digital device capable of displaying a digital image, such as, for example UI device 250 or IoT device 260. In this example, display 600 shows a line graph 610 and four cards 620, 630, 640, 650. Other visualizations will result in different combinations of cards, graphs, charts, and/or other types of visual representations of data. In this example card 620 shows SubMeter1 energy usage as a number (for example, a number of kilowatt-hours), and card 630 shows a prediction of SubMeter1 energy usage as a number (for example, a number of predicted kilowatt-hours). In this example, card 650 shows total energy usage of the building as a number. Card 640 represents one or more other cards that show various other measurements or data. Multi-line chart 610 shows SubMeter1 energy usage as one line in multi-line chart 610 and the prediction of SubMeter1 energy usage as another line in multi-line chart 610. In other examples, the lines of multi-line chart 610 can represent energy usage in areas represented by other submeters, the energy usage in the total building, and/or any other parameter related to data accessible by semantic meta model generation module 200. In embodiments, each vertex (oval immediately below rectangle 500) in visualization 500 has at least one associated card on display 600. In the example shown in FIG. 6, cards 620 and 630 are associated with SubMeter1 Energy Usage and Prediction Visualization 510, and card 650 is associated with Energy Usage Building Visualization 520.

As discussed above, embodiments of the invention include: defining a visualization which includes details of what type of chart/card needs to be displayed, and including this definition as one of the dimensions of the semantic meta model; associating a semantic meta model reasoning query with the type of visualization; providing the discovery API which is consumable by UI users to list all the possible visualizations available to end users for using it on their respective dashboards; and/or providing the generic API which provides the results of the reasoning query in a format that can be displayed directly on the particular UI.

By including the visualization definition as a dimension of the semantic meta model, embodiments of the invention avoid the need for additional coding to enable the semantic meta model to be displayed on UI device 250 or IoT device 260. After the visualization definition is generated by the semantic meta model generation module 200, the visualization definition is transmitted with the semantic meta model to UI device 250 or IoT device 260 as a part of the semantic meta model.

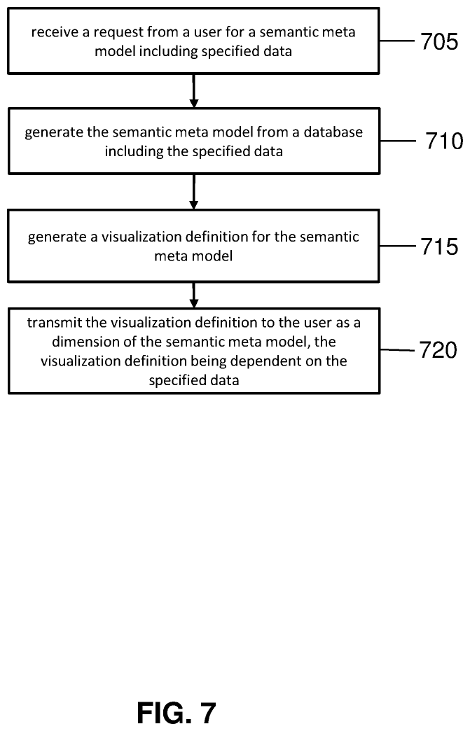

FIG. 7 shows a flowchart of an exemplary method in accordance with aspects of the present invention. Steps of the method may be carried out in the environment of FIG. 4 and are described with reference to elements depicted in FIGS. 4-6.

At step 705, the system receives a request from a user device for a semantic meta model including specified data. In embodiments, and as described with respect to FIG. 4, the semantic meta model generation module 200 of computer device 100 receives the request from UI device 250 or IoT device 250 through cloud computing environment 50. At step 710, the semantic meta model is generated from a database that includes the specified data. In embodiments, and as described with respect to FIG. 4, the semantic meta model generation module 200 of computer device 100 generates the semantic meta model from database 150 based on the request from step 705. In embodiments, database 150 resides on a storage device 120 that is a part of computer device 100. In other embodiments, database 150′ resides on a storage device 120′ that is remote from computer device 100 such as, for example, a storage device that is accessed by computer device 100 through cloud computing environment 50 or some other wireless or wired connection.

At step 715, the system generates a visualization definition for the semantic meta model that was generated at step 710. In embodiments, and as described with respect to FIGS. 4 and 6, the semantic meta model generation module 200 of computer device 100 generates the visualization definition based on the reasoning queries 512, 522 and the types of visualizations 514, 524 shown in FIG. 6. As step 720, the system transmits the visualization definition to the user device as a dimension of the semantic meta model, the visualization definition being dependent on the specified data. In embodiments, and as described with respect to FIG. 4, the semantic meta model generation module 200 of computer device 100, another component of computer device 200, or computer device 200 itself, transmits the semantic meta model (with the visualization definition as a dimension thereof) through cloud computing environment 50 to UI device 250 used by the user.

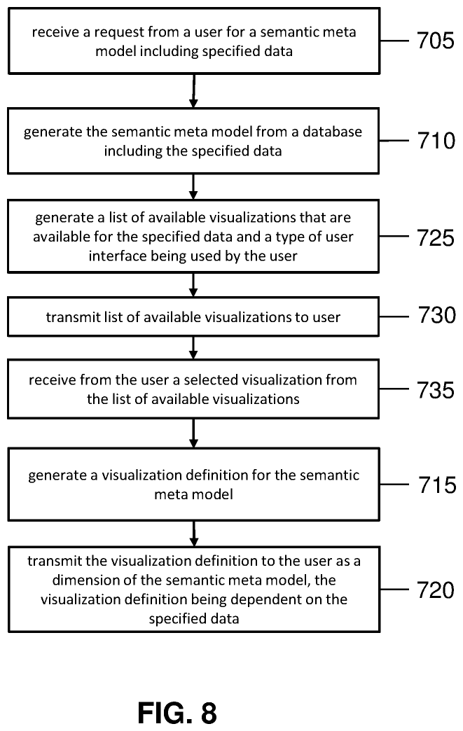

FIG. 8 shows a flowchart of an exemplary method in accordance with aspects of the present invention. Steps of the method may be carried out in the environment of FIG. 4 and are described with reference to elements depicted in FIGS. 4-6.

FIG. 8 is similar to FIG. 7, but includes additional steps 725, 730, and 735. At step 725, in some embodiments, a list of available visualizations that are available for the specified data and a type of user interface being used by the user is generated (through the discovery API discussed above). In embodiments, and as described with respect to FIG. 4, the semantic meta model generation module 200 of computer device 100, generates the list of available visualizations. At step 730, the system transmits the list of available visualizations to the user. In embodiments, and as described with respect to FIG. 4, the semantic meta model generation module 200 of computer device 100, another component of computer device 200, or computer device 200 itself, transmits the list of available visualizations through cloud computing environment 50 to UI device 250 used by the user. At step 735, the system receives from the user device a selected visualization from the list of available visualizations. In embodiments, and as described with respect to FIG. 4, the semantic meta model generation module 200 of computer device 100, another component of computer device 200, or computer device 200 itself, receives the visualization selection through cloud computing environment 50 from UI device 250 used by the user. This selection is used by semantic meta model generation module 200 to generate the visualization definition in step 715.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
receiving, by a computer device, a request from a user for a semantic meta model including specified data;
generating, by the computer device, the semantic meta model from a database including the specified data;
generating, by the computer device, a visualization definition for the semantic meta model, the visualization definition including computer readable instructions for generating an appearance of the semantic meta model on a digital display; and
transmitting, by the computer device, the visualization definition to the user as a dimension of the semantic meta model.

2. The computer-implemented method of claim 1, wherein the visualization definition is based on the specified data.

3. The computer-implemented method of claim 2, wherein the visualization definition includes a type of chart in which the specified data is presented, and
the type of chart is dependent on the specified data.

4. The computer-implemented method of claim 2, wherein the visualization definition is based on the user.

5. The computer-implemented method of claim 2, wherein the visualization definition is based on a user profile of the user.

6. The computer-implemented method of claim 5, wherein the user profile includes a role of the user, and
the role determines a parameter of the visualization definition.

7. The computer-implemented method of claim 1, further comprising generating a list of available visualizations that are available for the specified data.

8. The computer-implemented method of claim 7, further comprising receiving from the user a selected visualization from the list of available visualizations.

9. The computer-implemented method of claim 7, wherein the list of available visualizations is based on a type of user interface being used by the user.

10. The computer-implemented method of claim 9, wherein the list of available visualizations includes a default visualization for the specified data based on the type of user interface being used by the user.

11. The computer-implemented method of claim 7, wherein the list of available visualizations includes a default visualization for the specified data.

12. The computer-implemented method of claim 1, wherein the computer device includes software provided as a service in a cloud computing environment.

13. A computer program product, the computer program product comprising a computer readable storage medium having program instructions embodied therewith, the program instructions executable by a computer device to cause the computer device to:
receive a request from a user for a semantic meta model including specified data;
generate the semantic meta model from a database including the specified data;
generate a visualization definition for the semantic meta model, the visualization definition including computer readable instructions for generating an appearance of the semantic meta model on a digital display; and
transmit the visualization definition to the user as a dimension of the semantic meta model.

14. The computer program product of claim 13, wherein the visualization definition is dependent on the specified data.

15. The computer program product of claim 14, wherein the visualization definition includes a type of chart in which the specified data is presented, and
the type of chart is dependent on the specified data.

16. The computer program product of claim 15, further comprising program instructions executable by the computer device to generate a list of available visualizations that are available for the specified data and a type of user interface being used by the user.

17. A system comprising:
a processor, a computer readable memory, and a computer readable storage medium;
program instructions to receive a request from a user for a semantic meta model including specified data;
program instructions to generate the semantic meta model from a database including the specified data;
program instructions to generate a visualization definition for the semantic meta model, the visualization definition including computer readable instructions for generating an appearance of the semantic meta model on a digital display; and
program instructions to transmit the visualization definition to the user as a dimension of the semantic meta model,
wherein the program instructions are stored on the computer readable storage medium for execution by the processor via the computer readable memory.

18. The system of claim 17, wherein the visualization definition is dependent on the specified data.

19. The system of claim 18, further comprising program instructions to generate a list of available visualizations that are available for the specified data,
wherein the list of available visualizations is based on a type of user interface being used by the user.

20. The system of claim 17, wherein the processor is a cloud-based server.
